(19) United States
(12) Patent Application Publication
(10) Pub. No.: US 2022/0211221 A1
(43) Pub. Date: Jul. 7, 2022

(54) SINGLE-PART, WATERTIGHT WALL COVERING DEVICE WITH A SCREEN

(71) Applicant: NEWEL AG, St. Gallen (CH)

(72) Inventor: Jörg FIEDLER, Görlitz (DE)

(73) Assignee: NEWEL AG, St. Gallen (CH)

(21) Appl. No.: 17/600,634

(22) PCT Filed: Apr. 3, 2020
(86) PCT No.: PCT/EP2020/059611

§ 371 Date: Oct. 1, 2021

(30) Foreign Application Priority Data
Apr. 4, 2019 (DE) 102019108851.8

(51) Int. Cl. A47K 3/28; A47K 3/30; E03C 1/05; G06F 3/16; H05B 47/19

(52) U.S. Cl. CPC A47K 3/281; A47K 3/302; H05B 47/19; G06F 3/167; E03C 1/057

(57) ABSTRACT

A single-part, watertight wall covering device for dynamically displaying changing images on a wall surface on which the wall covering device is attached, includes a panel-type main body made of a transparent plastic having a front side and a rear side. At least one image generation element with a matrix-type pixel assembly is arranged on the rear side of the main body in such a way that an image generated by the image generation element/s is visible through the main body for an observer of the wall surface.

The invention relates to a single-part, watertight wall covering apparatus for dynamically presenting changing images on a wall surface that is at least one square meter in size and on which the wall covering apparatus is mounted.

Traditionally, the wall surfaces of baths and shower enclosures and also of kitchens above the countertops thereof are covered with tiles. The older such tiling is, the greater will be the problems resulting from a decreasing leak-tightness of the joints between said tiles. In addition, the design of tiles is subject to fashion aspects, which means that tiles picked on the basis of esthetic aspects when they were applied no longer meet changed esthetic demands after a few years, which results in either the prior tiles, once they have been removed, being replaced with new tiles or the prior tiles being covered by gluing on new tiles, wherein the removal of the old tiles creates enormous work while repeatedly gluing on new ones is subject to certain limits due to the growing thickness of the tiles being repeatedly arranged one above the other.

In addition, the behavior of people when consuming media has changed within the past twenty years to the point that media consumption has increased greatly even in functional spaces such as bathrooms and kitchens, that is to say that one no longer has only a kitchen radio or a bathroom radio, rather the constant availability of electronic media, access to social networks etc. at every location is increasingly considered to be routine and normal. In the normal case it is necessary in order to take into account these changed habits and this changed media usage behavior to keep not only the traditional radio but also a TV set, a computer, for example a tablet PC, etc. in spaces such as the bathroom and kitchen. In an average household, this results in a very heterogeneous IT infrastructure that is difficult to administer.

Even if one were to put these problems aside, further problems in such functional spaces remain:

For example, in the kitchen the user must arrange an open cookbook so as to use recipes, the use of which is difficult during cooking, that is to say with generally dirty fingers. Alternatively, the recipe can be displayed for example on a tablet PC, which in turn contributes to the above-described problem of a heterogeneous IT infrastructure.

A similar scenario applies to the bathroom. In accordance with conventional concepts, media consumption is possible here only by using devices that contribute to the above-described problem of a heterogeneous IT infrastructure, or the user uses their cellphone, which adversely influences the user experience due to the small screen or has not been possible at all to date, for example in the shower.

In particular in view of shower enclosures, it should moreover be noted that so far, there have been no concepts whatsoever for presenting music to the user for example in the shower, because a conventional bathroom radio is not capable of creating acceptable sound that travels the distance into the shower enclosure.

It is therefore an object of the invention to facilitate and improve media consumption in functional living spaces such as the bathroom and kitchen.

This object is achieved by a wall covering apparatus having the features of claim 1. Advantageous refinements and developments are the subject matter of the dependent claims.

Therefore, initially a single-part, watertight wall covering apparatus for dynamically presenting changing images on a wall surface on which the wall covering apparatus is mounted is proposed, comprising a panel-shaped main body made of a clear-as-glass plastic, having a front side and a rear side, wherein at least one image generation element having a matrix-type pixel arrangement is arranged on the rear side of the main body in a manner such that an image generated by the image generation element(s) is visible through the main body for a viewer of the wall surface.

The proposed wall covering apparatus is able to be used in many ways and offers a significant additional benefit to the user compared to conventional wall coverings:

The panel-shaped main body consists of a clear-as-glass plastic which, first of all, makes it possible to cover large wall surfaces, for example a wall of a shower enclosure, a wall above a kitchen block, and the like, without joints and in an absolutely watertight manner. The proposed wall covering apparatus can here cover very large wall surfaces, because clear-as-glass plastic panels are commercially available without difficulty in sizes of several square meters.

Using the proposed wall covering apparatus, it is moreover possible to present static or dynamic image contents directly on the wall surface; a separate TV set or a separate computer monitor is not necessary herefor. The proposed wall covering apparatus can thus make an important contribution to the current trend of the ever-present human/computer interaction (“ubiquitous computing”), because people can access information and contents, electronic media etc. at any location without carrying a portable device that must typically be held in the hand and can thus make performing other actions difficult. By using the proposed wall covering apparatus in the living environment, in spaces such as the kitchen or the bathroom, it is possible to take account not only of the purely protective function for the building body, but also of the requirements of the residents for information and entertainment. Even if such functions are currently not necessary, the wall surface on which the proposed wall covering apparatus is mounted, can be visually designed in a pleasing manner because any desired patterns are presentable. It is likewise possible to present for example dynamic images of a fish tank or the like, which can serve for calming the user and help them to mentally collect themselves.

Since the wall covering device should expediently be fixedly connected, like conventional wall tiles, to the wall surface that is to be covered, it is sensible if the image generation element(s) have a small installation height, develop as little heat as possible, and require no maintenance. In this case, the image generation element can have a dedicated carrier substrate that is as thin as possible, and on which the matrix-type pixel arrangement is mounted and which is adhesively bonded for example to the rear side of the panel-shaped main body.

The at least one image generation element can be, for example, an LCD panel that is backlit from the rear side (also known as a “backlit panel”), for example by arranging LEDs.

In an expedient refinement of the wall covering apparatus, however, it is proposed that the at least one image generation element is applied directly to the rear side of the main body in a thin-film process. Suitable for this are in particular OLED image generation elements that can be applied to the rear side of the main body for example in an inkjet printing method. These OLED image generation elements have the additional advantage that they are self-luminous. High-energy and typically heat-generating background illumination as in the case of LED image generation elements can thus be dispensed with.

In a further, particularly beneficial refinement of the wall covering apparatus, however, it is proposed that the at least one image generation element is made up of micro-LEDs. Just like with the OLED displays, the individual pixels are self-luminous with this technology. However, they are not based on organic light-emitting diodes, but on semiconductor light-emitting diodes having a size in the micrometer range. These inorganic micro-LEDs offer significant advantages regarding brightness, switching times, and operating temperature in comparison with LCD and OLED technology. In a micro-LED display, no TFT matrix is necessary for the control either, but the LED is integrated together with a control IC directly on a substrate by way of micro transfer printing. The micro-LED displays can be produced in principle to be lighter and thinner than existing displays and, with a contrast ratio that is comparable to that of OLEDs, are even superior in terms of color presentation and power consumption.

In order to be able to operate the proposed wall covering apparatus as easily as possible, a further refinement may make provision for at least one two-dimensional touch sensor to be arranged on the rear side of the main body. The touch sensor is thus likewise protected against moisture. The wall covering apparatus can be operated by the user easily by touching and swiping gestures on the front side of the main body, to which the two-dimensional touch sensor arranged on the rear side of the main body reacts. The two-dimensional touch sensor may cover only a partial surface of the panel-shaped main body. In this case, for example an optical boundary mark on the main body can indicate the touch-sensitive region thereof. However, the two-dimensional touch sensor can also extend over the entire surface of the wall covering apparatus.

As in the case of the image generation element, the two-dimensional touch sensor can have a dedicated carrier substrate that is as thin as possible, on which a two-dimensional sensor arrangement is mounted and which is adhesively bonded for example to the rear side of the panel-shaped main body. However, for the same reasons as already described above with respect to the image generation element, it is possible in a particularly expedient refinement of the wall covering apparatus for the at least one two-dimensional touch sensor to be likewise applied directly to the rear side of the main body in a thin-film process, for example using an inkjet printing method.

The proposed wall covering apparatus is already fully marketable with the features that have been described so far. Solutions by other sellers could be combined with the wall covering apparatus for controlling the image generation element, possibly based on user commands entered via a touch sensor.

For optimally using the potential of the wall covering apparatus, however, it is expedient for the wall covering apparatus to be delivered with a control device that has been adapted to the image generation element(s) and possibly to the touch sensor(s) and is connected, after the installation of the wall covering apparatus, wirelessly or with wires to the at least one image generation element for generating a static or dynamic image using the image generation element. The control device can here be mounted on the rear side of the main body and be fixedly wired, for example, to the image generation element(s) and possibly to the touch sensor(s).

However, the control device can also be wirelessly connected to the image generation element(s) and possibly to the touch sensor(s). This variant has the advantage that the control device can be accessed more easily for maintenance purposes, possibly can be replaced and be set up at any desired location, for example near an Internet router.

In this case, it is merely necessary to ensure that the wall covering apparatus has a corresponding wireless reception device that can receive (receiver) commands and data from the control device and can transmit them (driver) to the image generation element(s). If the wall covering apparatus additionally has touch sensors, the wall covering apparatus must additionally have a corresponding wireless transmission device that can pass commands and data on (transmitter) to the control device. Receiver, driver and transmitter can be combined in one integrated circuit.

In one advantageous refinement of the proposed wall covering apparatus, provision may furthermore be made for the control device to be configured to connect wirelessly or with wires to a data network or/and to at least one external device. For example, the control device can have a LAN or WLAN interface in order to connect to an Internet router, with the result that contents from the Internet can be streamed onto the wall covering apparatus.

The wall covering apparatus for this purpose can be configured such that the control device reproduces on the at least one image generation element the content of a display device of an external device, for example by the standards Google Android Auto, Apple CarPlay, Ford AppLink, SmartDeviceLink (SDL) etc., or/and of operating elements for external devices such as NAS (network attached storage), media players etc., or/and of colors or color gradients or/and of geometric patterns or/and of web contents (by way of http or https) or/and of movies or/and of electronic messages (email, SMS, MMS, messenger services such as Skype, Whatsapp and the like) or/and from weather forecasts.

According to a further refinement, provision may be made in the proposed wall covering apparatus for the control device to be configured for controlling at least one loudspeaker or/and a mixer faucet for setting a water temperature or/and an illumination device or/and an infrared source.

Provision may be made, for example, for at least one loudspeaker driver to be arranged on the rear side of the main body in a manner such that the main body is caused to oscillate for the purpose of reproducing acoustic signals. This loudspeaker driver can be connected wirelessly or with wires to the control device according to one development of the proposed wall covering apparatus such that a high-quality sound is output that is associated with the static or in particular dynamic image, for example a movie, that is produced by the image generation element(s) for example in a shower enclosure provided with one or more of the proposed wall covering apparatuses. It is likewise possible that the control device provides the loudspeaker driver with the signal of a radio transmitter in order to output music at high quality, while the image generation element(s) produce for example plays of color or geometric patterns or display the video relating to the current song.

Alternatively or additionally, a mixer faucet can be electrically controllable using the control device of the proposed wall covering apparatus, as a result of which it becomes unnecessary in principle for operating elements of the mixer faucet to be arranged within a shower enclosure. Rather, the entire mixer faucet can be arranged in the wall, for example behind the proposed wall covering apparatus, and be controlled in a closed loop using electrical signals by the control device, i.e. the desired volume flow of the water that is output and the temperature thereof can be set and possibly controlled in a closed loop.

In the same way, provision may be made for an illumination device to be controlled by the control device. In this case, it may be for example the room illumination whose intensity or/and color hue is set. Alternatively or additionally, the control device can also control a light therapy device, which is arranged for example in the region of the shower enclosure and typically generates different colors according to specific patterns.

Infrared sources for what are known as heat cabins are also known in two-dimensional embodiments. In a further refinement, an infrared source is arranged for example behind the panel-shaped main body of the proposed wall covering apparatus and is controlled in a closed loop by the control device. This application is suitable both for shower enclosures and also for specific heat cabins in which the user sits on a bench in the manner of a sauna. In such heat cabins—as in saunas—the proposed wall covering apparatus can be used with great additional benefit for the user.

According to a further refinement of the proposed wall covering apparatus, provision may be made for a touch of the main body in the region of the two-dimensional touch sensor to bring about a visual presentation of an operating element for operating an external device using an image generation element. This may be, for example, operating elements for TV sets, radios, media players, smartphones, computers and the like, in order to allow the reproduction of the corresponding contents in a visual or/and acoustic manner on or using the proposed wall covering apparatus and to set for example the desired volume as well.

In the case of operating elements of a mixer faucet, the user can in this way set the desired volume flow of the water that is output and the temperature thereof. In the case of operating elements for an illumination device, the brightness and possibly the color or/and the color pattern of the output light can in this way be set by the user. In the case of operating elements for an infrared source, the intensity of the radiation and the duration thereof can in this way be set by the user.

In a further refinement of the proposed wall covering apparatus, provision may be made for a plurality of image generation elements to be arranged in the manner of a matrix on the rear side of the main body and to be embodied with a common control device for generating an image, wherein each image generation element generates one part of the image and the arrangement of all image generation elements generates the entire image. This may make sense in particular if the proposed wall covering apparatus is intended to be so large that the resolution of an individual image generation element no longer results in a satisfactory image impression, that is to say the image that is generated appears pixelated.

In the proposed wall covering apparatus, provision may furthermore be made for the main body to have at least one opening, in which no image generation element is arranged. Such openings can be used for example for guiding through a water armature or a shower head or for letting through a waterfall. In other words, if there is no intention to use an electrically settable water armature, it is also possible with this refinement to use conventional armatures in which the operating elements or/and the shower head are arranged at the wall. The third alternative refers to shower enclosures, in which a waterfall-type waterjet emerges from a slit in the wall.

Finally, provision may be made in the case of the proposed wall covering apparatus for the control device to be connected to a microphone or for the wall covering apparatus or the control device to have a microphone, wherein the control device is configured to be operated using voice commands. In this refinement, it is possible to dispense with a two-dimensional touch sensor, and the user enters their commands only by way of voice. It is, however, of course just as possible for the user to choose between touch and voice commands if the proposed wall covering apparatus has a touch sensor and the control device is also connected to a microphone, or the wall covering apparatus or the control device has a microphone.

The invention will be explained in more detail below with reference to an exemplary embodiment and associated drawings, in which

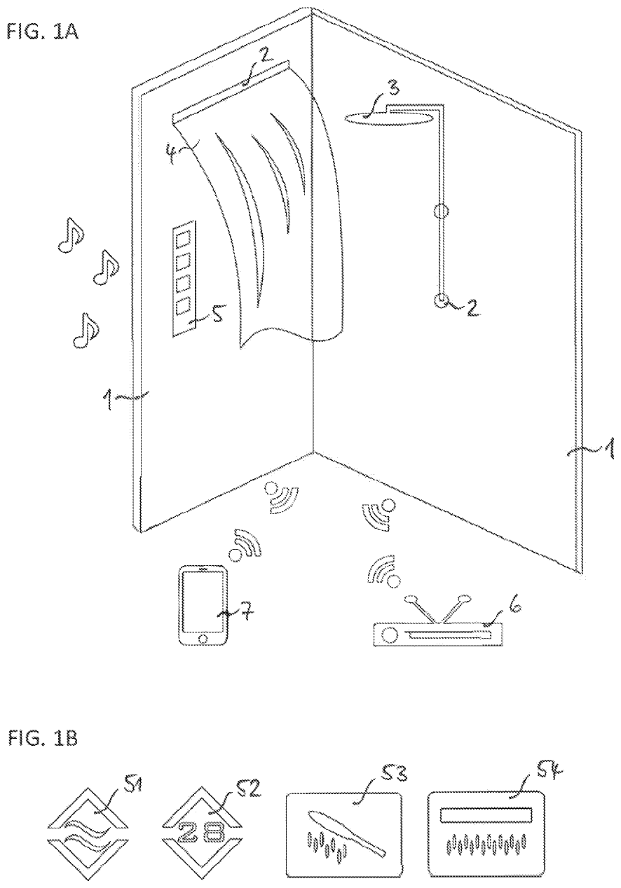

FIG. 1A shows a shower enclosure in which two walls are covered by a proposed wall covering apparatus,

FIG. 1B shows exemplary operating elements, and

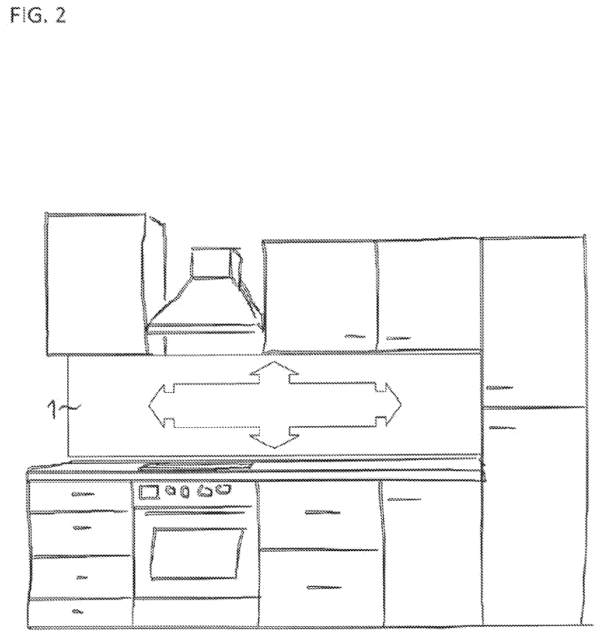

FIG. 2 shows a fitted kitchen, in which the wall above the kitchen block is covered with a proposed wall covering apparatus.

The shower enclosure illustrated in FIG. 1A has two single-part, watertight wall covering apparatuses for dynamically presenting changing images, which are mounted on the walls that connect in a corner of a room. Each of the two wall covering apparatuses has a panel-shaped main body 1 made of a clear-as-glass plastic. A full-area image generation element is arranged on the rear side of each main body 1. In other words, two walls of the shower enclosure are embodied in the form of large monitors that occupy the entire surface area of the respective wall. The glass walls, which are usually used for forming a shower enclosure, are not illustrated in FIG. 1A.

A control device 6 for generating images is connected wirelessly to the image generation elements of the two wall covering apparatuses and to a data network and to an external device 7. The control device 6 acquires data optionally from the data network or from the external device 7 and controls the two image generation elements for presenting images, for example a movie with underwater recordings.

The control device 6 additionally controls loudspeakers, which are arranged behind the main bodies 1 of the wall covering apparatuses and emit sounds.

If the main body 1 is touched, a visual presentation of operating elements 5 is displayed. In FIG. 1B, exemplary embodiments of such operating elements 5 for a mixer faucet for selecting a water source (shower head 53 or waterfall 54), for setting the amount of water 51 and for setting the water temperature 52 are shown.

In the case of the wall covering apparatus arranged on the left-hand side in the selected illustration, the main body 1 has an opening 2, in which no image generation element is arranged and which serves for letting through a waterfall 4.

In the wall covering apparatus arranged on the right-hand side in the selected illustration, the main body 1 has an opening 2 that serves for guiding through the supply line for a shower head 3.

FIG. 2 illustrates a fitted kitchen, in which a large-area single-part, watertight wall covering apparatus, which is likewise configured for dynamically presenting image contents, is arranged in a region above the countertops and below wall cabinets that are secured to the walls.

The main body 1 of the wall covering apparatus protects the wall against wetness and soiling. At the same time, the image generation element arranged behind the main body 1 can be used to dynamically present a plurality of different image contents, which can be positioned freely by being dragged to a desired location using touch and swiping gestures. For example, it is thus possible to display above the cooktop an Internet browser, in which a recipe is displayed. At the same time, it is possible at different locations of the main body 1 for, for example, a weather forecast, a clock, a media player and the like to be displayed. Using loudspeakers arranged behind the main body, music can be emitted.

### LIST OF REFERENCE SIGNS

1 Main body
2 Opening
3 Shower head
4 Waterfall
5 Operating element
51 Operating element—amount of water
52 Operating element—water temperature
52 Operating element—water source shower head
52 Operating element—water source waterfall
6 Control device
7 External device

1. A single-part, watertight wall covering apparatus for dynamically presenting changing images on a wall surface on which the wall covering apparatus is mounted, comprising a panel-shaped main body made of a clear-as-glass plastic, having a front side and a rear side, wherein at least one image generation element having a matrix-type pixel arrangement is arranged on the rear side of the main body in a manner such that an image generated by the image generation element(s) is visible through the main body for a viewer of the wall surface.

2. The wall covering apparatus as claimed in claim 1, in which the at least one image generation element is applied directly to the rear side of the main body in a thin-film process.

3. The wall covering apparatus as claimed in claim 1, in which at least one two-dimensional touch sensor is arranged on the rear side of the main body.

4. The wall covering apparatus as claimed in claim 3, in which the at least one two-dimensional touch sensor is applied directly to the rear side of the main body in a thin-film process.

5. The wall covering apparatus as claimed in claim 1, in which a control device is connected wirelessly or with wires to the image generation element for generating a static or dynamic image using the at least one image generation element.

6. The wall covering apparatus as claimed in claim 5, in which the control device is configured to connect wirelessly or with wires to a data network or/and to at least one external device.

7. The wall covering apparatus as claimed in claim 5, in which the control device is configured to reproduce on the at least one image generation element the content of a display device of an external device or/and of operating elements for external devices or/and of colors or color gradients or/and of geometric patterns or/and of web contents or/and of films or/and of electronic messages or/and of weather forecasts.

8. The wall covering apparatus as claimed in claim 5, in which the control device is configured for controlling at least one loudspeaker or/and a mixer faucet for setting a water temperature or/and an illumination device or/and an infrared source.

9. The wall covering apparatus as claimed in claim 8, in which at least one loudspeaker driver is arranged on the rear side of the main body in a manner such that the main body is caused to oscillate for the purpose of reproducing acoustic signals.

10. The wall covering apparatus as claimed in claim 3 to 8, in which a touch of the main body in the region of the two-dimensional touch sensor brings about a visual presentation of an operating element for operating an external device using an image generation element.

11. The wall covering apparatus as claimed in claim 5, in which a plurality of image generation elements are arranged in the manner of a matrix on the rear side of the main body and are embodied with a common control device for generating an image, wherein each image generation element generates one part of the image and the arrangement of all image generation elements generates the entire image.

12. The wall covering apparatus as claimed in claim 1, in which the main body has at least one opening, in which no image generation element is arranged.

13. The wall covering element as claimed in claim 12, in which the opening serves for guiding through a water armature or a shower head or for letting through a waterfall.

14. The wall covering apparatus as claimed in claim 5, in which the control device is connected to a microphone, or the wall covering apparatus or the control device as a microphone, wherein the control device is configured to be operated using voice commands.

15. The wall covering apparatus as claimed in claim 2, in which at least one two-dimensional touch sensor is arranged on the rear side of the main body.

16. The wall covering apparatus as claimed in claim 4, in which a control device is connected wirelessly or with wires to the image generation element for generating a static or dynamic image using the at least one image generation element.

17. The wall covering apparatus as claimed in claim 16, in which the control device is configured for controlling at least one loudspeaker or/and a mixer faucet for setting a water temperature or/and an illumination device or/and an infrared source.

18. The wall covering apparatus as claimed in claim 17, in which at least one loudspeaker driver is arranged on the rear side of the main body in a manner such that the main body is caused to oscillate for the purpose of reproducing acoustic signals.

19. The wall covering apparatus as claimed in claim 18, in which a plurality of image generation elements are arranged in the manner of a matrix on the rear side of the main body and are embodied with a common control device for generating an image, wherein each image generation element generates one part of the image and the arrangement of all image generation elements generates the entire image.

20. The wall covering apparatus as claimed in claim 19, in which the main body has at least one opening, in which no image generation element is arranged.
